(19) United States
(12) Patent Application Publication
(10) Pub. No.: US 2006/0181501 A1
(43) Pub. Date: Aug. 17, 2006

(54) Driving apparatus and driving method of light emitting display panel

(75) Inventor: Toshihiko Aoki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/346,267

(22) Filed: Feb. 3, 2006

(30) Foreign Application Priority Data
Feb. 15, 2005 (JP) 2005-037898

(51) Int. Cl. G09G 3/36

(52) U.S. Cl. 345/100

(57) ABSTRACT

An analog image signal is supplied to a driving controlling circuit and an A/D converting circuit and is converted to image data corresponding to each one pixel by the A/D converting circuit and is written to an image memory. The image data is read from the image memory for each one scanning and the driving controlling circuit acquires the rate of organic EL devices to be lighted and controlled (lighting rate of light emitting devices for each one scanning). The data of a scanning selecting potential is read from a look-up table based on lighting rate and the data of dimmer setting and a scanning selecting potential in scanning selecting potential setting means is determined by the data of a scanning selecting potential. Current transiently charged to devices to be lighted from a non-scanning selecting power source (reverse bias power source) at the beginning of lighting of the light emitting devices because of a decrease in lighting rate is controlled as appropriate, whereby the occurrence of shadowing can be controlled.

### BACKGROUND OF THE INVENTION

1. Field of the Invention

This invention relates to a driving apparatus and a driving method suitably applied to a passive matrix type light emitting display panel using capacitive light emitting devices, and in particular, to a driving apparatus and a driving method of a light emitting display panel capable of reducing the degree of occurrence of shadowing (transverse cross talk) caused by a change in the lighting rate of the light emitting devices to a level that is of no problem in practical use.

2. Description of the Related Art

Cellular phones and personal digital assistants (PDA) have come into widespread use and hence the demand of a display panel having the function of displaying an image of high definition and having a low profile and capable of reducing power consumption has increased. Hence, liquid crystal display panels have been conventionally employed in many products as display panels satisfying the demand. Meanwhile, in recent years, organic electroluminescence (EL) devices taking advantage of a distinctive feature of a spontaneous light emission type device have become commercially available and receive attention as next-generation display panels substituting for the conventional liquid crystal display panels. As a backdrop to this, it is also thought that by using an organic compound expected to have excellent light emitting characteristics for the light emitting layer of an EL device, the EL device has come to have such a high efficiency and such a long life that are sufficient for practical applications.

The above-mentioned organic EL device is basically constructed in such a way that a transparent electrode (anode) made of, for example, ITO, a light emitting function layer, and a metal electrode (cathode) made of aluminum alloy are laminated in this order on a transparent substrate made of glass or the like. Then, the light emitting function layer has a single light emitting layer made of an organic compound; a two-layer structure including an organic hole transport layer and a light emitting layer; further, three-layer structure including an organic hole transport layer, a light emitting layer, and an organic electron transport layer; or still further, in some case, a multilayer structure having a hole injection layer formed between the above-mentioned transparent electrode and hole transport layer and having an electron injection layer formed between the above-mentioned metal electrode and electron transport layer. Then, light generated in the light emitting function layer is emitted outside through the transparent electrode and the transparent substrate.

The above-mentioned organic EL device can be electrically replaced with a construction including a light emitting element having diode characteristics and a parasitic capacity component combined in parallel with this light emitting element. Hence, it can be said that the organic EL device is a capacitive light emitting device. This organic EL device can be thought to operate as follows: when a light emitting driving voltage is applied to this organic EL device, first, electric charges corresponding to the electric capacity of the device flow into the electrode as a displacement current and are stored there; successively, when the voltage becomes larger than a specified voltage specific to the device (light emitting threshold voltage=Vth), current starts to flow from one electrode (anode side of diode component) to the light emitting function layer and emits light of intensity proportional to this current.

Meanwhile, in the organic EL device, a current—luminance characteristic is stable to a temperature change whereas a voltage—luminance characteristic is heavily dependent on a temperature change. Then, when the organic EL device receives overcurrent, the organic EL device is heavily degraded to make a light emitting life shorter. For these reasons, the organic EL device is usually driven at a constant current. A passive driving type display panel having organic EL devices arranged in a matrix is already commercially available in some use as a display panel using such organic EL devices.

FIG. 1 an example of a conventional passive matrix type display panel and its driving circuit is shown, and this example shows an embodiment of cathode line scanning/anode line driving mode. That is, m data lines (hereinafter also referred to as “anode lines”) A1 to Am are arranged in a longitudinal direction and n scanning lines (hereinafter also referred to as “cathode lines”) K1 to Kn are arranged in a lateral direction and organic EL devices E11 to Emn each shown by a symbol mark of a parallel combination of a diode and a capacitor are arranged at respective intersections of the data lines and the scanning lines, whereby a display panel 1 is constructed.

In correspondence with respective intersections of the anode lines A1 to Am along a longitudinal direction and the cathode lines K1 to Kn along the lateral direction, one ends (anode terminals in an equivalent diode of the organic EL device) of the respective organic EL devices E11 to Emn constructing pixels are connected to the anode lines and the other ends (cathode terminals in an equivalent diode of the organic EL device) are connected to the cathode lines. Moreover, the respective anode lines A1 to Am are connected to and driven by an anode line driving circuit 2 as a data driver and the respective cathode lines K1 to Kn are connected to and driven by a cathode line scanning circuit 3 as a scanning driver.

The anode line driving circuit 2 is provided with constant-current power sources I1 to Im as a lighting driving power source operating by the use of a driving voltage from a driving voltage power source VH and driving switches Sa1 to Sam as switching means. When the driving switches Sa1 to Sam are connected to the constant-current power sources I1 to Im, currents from the constant-current power sources I1 to Im are supplied as driving currents to the individual organic EL devices E11 to Emn arranged in correspondence with the cathode lines to be scanned.

Then, the driving switches Sa1 to Sam are constructed in such a way that a voltage from a voltage power source VAM or a reference potential point (grounding potential GND in the embodiment shown in FIG. 1) as a non-lighting driving power source is supplied to the individual organic EL devices E11 to Emn arranged in correspondence with the cathode lines.

Meanwhile, the cathode line scanning circuit 3 functioning as scanning selecting means is provided with scanning switches Sk1 to Skn as switching means in correspondence with the respective cathode lines K1 to Kn. The scanning switches Sk1 to Skn are constructed in such a way that either a reverse bias voltage from a reverse bias voltage power source VM functioning as a non-scanning selecting potential and mainly used for preventing cross-talk light emission or grounding potential GND as a reference potential point functioning as a scanning selecting potential can be supplied to the corresponding cathode lines.

Then, the anode line driving circuit 2 and the cathode line scanning circuit 3 have control signals supplied thereto respectively via a control bus from a light emission controlling circuit 4 including a CPU and the like to switch the scanning switches Sk1 to Skn and the driving switches Sa1 to Sam based on a signal of an image to be displayed. With this, constant-current power sources I1 to Im are connected to desired anode lines while the cathode lines are set at the grounding potential at a specified period based on the signal of an image to be displayed to selectively cause the respective organic EL devices to emit light to thereby display an image based on the above-mentioned signal of an image on the display panel 1.

In this regard, in the state shown in FIG. 1, a second cathode line K2 is set at the grounding potential, thereby being brought to a scanning state, and at this time, the respective cathode lines K1, K3 to Kn in a non-scanning state have a reverse bias voltage supplied thereto from the above-mentioned reverse bias voltage power source VM. Here, when the forward voltage of the organic EL device in a scanned and lighted state is Vf, the respective potentials are set in such a way as to satisfy the relationship of [(forward voltage Vf)−(reverse bias voltage VM)]<(light emitting threshold voltage Vth). Therefore, the respective organic EL devices at the intersections of the anode lines that are driven and cathode lines that are not selected and scanned are prevented from emit cross-talk light.

By the way, the respective organic EL devices arranged in the display panel 1 have individual parasitic capacities as described above and are arranged at the intersections of the anode lines and the cathode lines in a matrix. Hence, for example, taking a case where several tens organic EL devices are connected to one anode line as an example, when viewed from the anode line, a composite capacity of several hundred or more times the respective parasitic capacities is connected as a load capacity to the anode line. This composite capacity increases remarkably as the size of the matrix increases.

Therefore, at the beginning of the lighting scanning period of the organic EL devices, the currents from the constant-current power sources I1 to Im via the anode line are consumed to charge the above-mentioned composite load capacity and hence there occurs a time delay before the load capacity is charged to a level larger than the light emitting threshold voltage (Vth) of the organic EL device. Therefore, there is presented a problem that the start-up of the light emission of the organic EL device delays (becomes slow). In particular, in the case where the constant-current power sources I1 to Im as the driving sources of the EL devices are used, the constant-current power sources are high-impedance output circuits in the principle of operation and hence currents are limited to remarkably delay the start-up of the light emission of the organic EL devices.

Then, this reduces the lighting time rate of the organic EL devices and hence presents the problem of reducing the substantial emission luminance of the organic EL device. Then, to eliminate the delay of start-up of light emission of the organic EL device caused by the above-mentioned parasitic capacity, in the construction shown in FIG. 1, the operation of charging the organic EL devices to be lighted is performed by the use of the reverse bias voltage VM.

FIG. 2 shows such an operation of lighting and driving the organic EL device that includes a reset period during which the amount of electric charges charged to the parasitic capacity of the organic EL device to be lighted is cleared to zero. Here, FIG. 2A shows a scanning synchronizing signal and in this example, a reset period and a constant-current driving period (lighting period) are set in synchronization with the scanning synchronizing signal.

Then, FIGS. 2B and 2C show potentials to applied to lighting lines and non-lighting lines of the anode lines connected to the anode driver (anode line driving circuit) 2 in the above-mentioned respective periods. Then, FIGS. 2D and 2E show potentials to applied to the scanning lines and non-scanning lines of the cathode lines connected to the cathode driver (cathode line scanning circuit) 3 in the above-mentioned respective periods.

In the reset period shown in FIG. 2, as shown in FIG. 2B, the driving switches Sa1 to Sam as switching means provided in the anode driver 2 supply potential from the voltage power source VAM to the anode lines (lighting lines) corresponding to the organic EL devices to be lighted and controlled. Then, the driving switches Sa1 to Sam are controlled so as to supply the anode lines (non-lighting lines) corresponding to the organic EL devices not to be lighted, as shown in FIG. 2C, with the grounding potential GND as the reference potential of the circuit.

Meanwhile, the cathode driver 3 in the reset period applies a reverse bias voltage VM to the cathode lines (scanning lines) to be scanned and the cathode lines (non-scanning lines) not to be scanned by the scanning switches Sk1 to Skn as switching means provided in the cathode driver 3 as shown in FIGS. 2D and 2E, respectively.

Moreover, in the constant-current driving period of the lighting period of the organic EL devices, the anode lines (lighting lines) corresponding to the organic EL devices to be lighted have constant currents supplied from the constant-current power sources I1 to Im by the driving switches Sa1 to Sam, respectively. Then, the anode lines (non-lighting lines) corresponding to the organic EL devices not to be lighted have the grounding potential GND as the reference potential of the circuit set, as shown in FIG. 2C.

Meanwhile, in the above-mentioned constant-current driving period, the cathode driver 3 sets the ground potential GND of a scanning selecting potential to the cathode lines (scanning lines) to be scanned, as shown in FIG. 2D, and applies the reverse bias voltage VM of a non-scanning selecting voltage to the cathode lines (non-scanning lines) not to be scanned, as shown in FIG. 2E, by the scanning switches Sk1 to Skn, respectively.

In the above-mentioned construction, by causing the potential of the reverse bias voltage power source VM and the potential of the voltage power source VAM to satisfy the relationship of VM=VAM, in the reset period, the amount of charge of the parasitic capacity can be cleared to zero in all organic EL devices connected to the lighting lines. Then, just after moving to the above-mentioned constant-current driving period, current transiently flows into the organic EL devices to be lighted from the reverse bias voltage power source VM via the organic EL devices not scanned to rapidly charge the parasitic capacities of the organic EL devices to be lighted. As a result, the organic EL devices to be lighted can start emitting light comparatively quickly.

As described above, a passive driving type display apparatus for pre-charging the organic EL devices to be lighted and driven by the use of the reverse bias voltage is disclosed in the Japanese Unexamined Patent Publication No. Hei 9-232074 shown in the following or the like.

By the way, in the passive driving type apparatus of the above-mentioned construction, it is known that variation in emission luminance, that is, so-called shadowing (transverse cross talk) occurs between the respective organic EL devices corresponding to the respective scanning lines which are different in the lighting rate, depending on the lighting rate of the organic EL devices. FIG. 3 and FIG. 4 show a state in which the shadowing occurs.

FIGS. 3A and 3B show the state of applying voltage to the organic EL devices in a reset period and in a constant-current driving period according to the timing chart shown in FIG. 2, respectively, and show a case where the lighting rate of the organic EL devices is 10% as an example. Here, for the reason the area of paper, FIGS. 3A and 3B show a state where potential is supplied to the respective organic EL devices corresponding to the 1st, 2nd, and m-th anode lines and the 1st, 2nd, and n-th cathode lines, respectively.

As shown in FIG. 3A, in the reset period, all of the scanning switches Sk1 to Skn are connected to the VM side and hence the reverse bias voltage VM is applied to the respective scanning lines K1 to Kn. Then, all of the driving switches Sa1 to Sam are connected to the VAM side. Here, as described above, there is the relationship of VM=VAM between the potential of the reverse bias voltage power source VM and the voltage power source VAM. Therefore, in the reset period shown in FIG. 3A, the potential difference between both ends of all of the organic EL devices becomes null and hence the amount of charges charged to the parasitic capacities for the organic EL devices becomes zero.

Meanwhile, in the constant-current driving period, as shown in FIG. 3B, the scanning line to be scanned and lighted, for example, the first scanning line K1 is set at the grounding potential GND via the scanning switch Sk1 and the other scanning lines have the reverse bias voltage VM applied successively via the scanning switches Sk2 to Skn. Then, at this time, all of the driving switches Sa1 to Sam are connected to the constant-current sources I1 to Im.

With this, the respective organic EL devices connected to the first scanning line K1 have the lighting driving current supplied from the respective constant-current sources I1 to Im. At this time, current flowing into the parasitic capacities of the organic EL devices not to be scanned from the reverse bias potential VM transiently flows into the anode side of the organic EL devices to be lighted through the respective anode lines to rapidly charge the parasitic capacities of the organic EL devices to be lighted. As a result, the organic EL devices to be lighted comparatively quickly start emitting light.

Next, FIG. 4 shows the example of operation when the lighting rate of the organic EL devices is reduced. FIGS. 4A and 4B, like FIG. 3, show the state of supplying potential to the respective organic EL devices in the reset period and in the constant-current driving period, respectively. However, in the example shown in this FIG. 4, the organic EL devices corresponding to the 1st and 2nd anode lines are not lighted and the organic EL device corresponding to the m-th anode line is lighted. Therefore, in the range shown in this FIG. 4, it can be said that the lighting rate of the organic EL devices is 33%.

In the reset period, as shown in FIG. 4A, the respective scanning lines K1 to Kn have the reverse bias voltage VM applied thereto. Then, the 1st and 2nd anode lines A1, A2 are connected to the grounding potential GND and the m-th anode line Am is connected to the VAM side. With this, the potential difference between both ends of the respective organic EL devices connected to the m-th anode line Am becomes null and hence the amount of charges charged to the parasitic capacities of the respective EL devices connected to the m-th anode line Am becomes zero. Meanwhile, the respective organic EL devices connected to the 1st and 2nd anode lines A1, A2 controlled to a lighting state have the reverse bias voltage by the VM applied thereto, thereby being charged in polarities shown in the drawing.

Successively, in the constant-current driving period, as shown in FIG. 4B, a scanning line to be scanned and lighted, for example, the 1st scanning line K1 is set at the grounding potential GND and the other scanning lines have the reverse bias voltage VM applied thereto successively. At this time, the 1st and 2nd anode lines A1, A2 controlled to a non-lighting state are set at the grounding potential GND and the m-th anode line Am to be lighted and controlled is connected to the constant-current power source Im.

With this, the organic EL devices that are connected to the 1st scanning line K1 and the m-th anode line Am and are to be lighted have the lighting driving current supplied from the constant-current power source Im. At this time, current flowing into the parasitic capacities of the organic EL devices not scanned from the reverse bias voltage power source VM transiently flows into the anode side of the organic EL devices to be lighted through the respective anode lines to rapidly charge the parasitic capacities of the organic EL devices to be lighted. As a result, the organic EL devices to be lighted start emitting light comparatively quickly.

Here, the organic EL devices not to be lighted have the reverse bias voltage by VM already charged as described above, which is not changed, and hence there is hardly the transient inflow of current from the reverse bias voltage power source VM via the anode lines A1, A2 not to be lighted. As a result, there is hardly a voltage drop in the reverse bias voltage in the cathode lines K2 to Kn in the non-scanning state and hence current transiently flowing into the anode side of the organic EL devices to be scanned and lighted via the respective cathode lines K2 to Kn in the non-scanning state and the anode line Am to be lighted increases as compared with a state shown in FIG. 3. With this, luminance at the beginning of light emission of the organic EL devices to be scanned and lighted rises up sharply as compared with the example shown in FIG. 3.

In short, the organic El devices to be lighted are pre-charged by current from the above-mentioned VM (detouring current passing through the parasitic capacities of the organic EL devices connected to the non-scanning lines) and hence the time constant of charging (load of capacity) of the whole of display panel changes according to the lighting rate of the organic EL devices for each scanning. For this reason, the amount of current that transiently flows into the anode side of the organic EL devices to be lighted changes particularly according to the lighting rate. This causes shadowing.

FIG. 5 schematically shows an example of shadowing caused by the action described above. In a display pattern shown in FIG. 5, a double hatched portion “A” shows an area where the organic EL devices are brought into a non-lighting state and portions “B” and “C” show areas where the organic EL devices are brought into a lighting state. As shown by “A” in FIG. 5, in the case where the rate of the unlighted devices is large (the lighting rate is small) when viewed for each scanning line, “bright transverse cross talk” in which the portion shown by “B” emits light more brightly than the portion shown by “C” is caused by the above-mentioned operation.

The example described above is based on a VM reset method for applying the above-mentioned reverse bias voltage VM to the organic EL devices in the reset operation method. In contrast to this, it is known that in the case of a GND rest mode in which both ends of the organic EL devices are set at the grounding potential GND in the reset operation mode, “dark transverse cross talk” is generally caused in which the portion shown by “B” in FIG. 5 emits light more darkly than the portion shown by “C”. Then, the above-mentioned shadowing is changed to various states by the factors of the display pattern, time constant, and the like of the display panel.

Meanwhile, it is known that as a dimmer value in the dimmer display of controlling the entire variations of light and shade of the display panel is set at a lower value, so the degree of occurrence of the above-mentioned shadowing becomes remarkable. This is because as the dimmer value is set at a lower value, the light emitting time of the organic EL device in one scanning period becomes shorter or the value of driving current becomes smaller and hence the electric charges flowing via the data lines of the organic EL devices being scanned via the parasitic capacities of the organic EL devices are thought to relatively highly contribute to the shadowing.

### SUMAMRY OF THE INVENTION

This invention has been made by paying attention to a problem of the above-mentioned shadowing caused particularly when the lighting rate of each scanning line of the organic EL devices is low and a problem of the above-mentioned shadowing that is more remarkably caused as a dimmer value by dimmer control is set at a lower value, as described above. The object of the present invention is to provide a driving apparatus and a driving method of a light emitting display panel, of the type capable of reducing the shadowing to a level that is of no problem in practical use.

A fundamental mode of a driving apparatus according to the present invention made to solve the above-mentioned problem is a driving apparatus of a light emitting display panel, of the type lighting and driving a passive matrix type display panel including a plurality of scanning lines, a plurality of data lines that intersect the plurality of scanning lines, respectively, and light emitting devices each of which is connected between each of the scanning lines and each of the data lines at an intersection of each of the scanning lines and each of the data lines, and is characterized by including:

scanning selecting means for applying a scanning selecting potential or a non-scanning selecting potential to each of the scanning lines;

lighting rate acquiring means for acquiring a rate PN of the light emitting devices to be lighted and controlled of the light emitting devices connected to the respective scanning lines; and

scanning potential setting means capable of controlling the scanning selecting potential based on the rate PN acquired by the lighting rate acquiring means.

Moreover, a fundamental mode of a driving method according to the present invention made to solve the above-mentioned problem is a driving method of a light emitting display panel, of the type lighting and driving a passive matrix type display panel including a plurality of scanning lines, a plurality of data lines that intersect the plurality of scanning lines, respectively, and light emitting devices each of which is connected between each of the scanning lines and each of the data lines at an intersection of each of the scanning lines and each of the data lines, and is characterized by implementing:

a step of acquiring a rate PN of the light emitting devices to be lighted and controlled of the light emitting devices connected to the respective scanning lines; and

a step of controlling a scanning selecting potential to be applied to scanning lines to be scanned based on the rate PN acquired by the step and supplying light emitting devices, which are connected to the scanning lines and are to be lighted, with lighting driving currents.

### BRIEF DESCRIPTION OF THE DRAWINGS

FIG. 1 is a circuit diagram showing one example of a conventional passive matrix type display panel and its driving circuit;

FIG. 2 is a timing chart showing a lighting driving operation in the display panel shown in FIG. 1;

FIG. 3 is a circuit diagram showing an operation when the lighting rate of light emitting devices according to the timing chart shown in FIG. 2 is high;

FIG. 4 is a circuit diagram showing an operation when the lighting rate of light emitting devices according to the timing chart shown in FIG. 2 is low;

FIG. 5 is a schematic diagram showing an example in which shadowing occurs;

FIG. 6 is a circuit diagram showing the basic construction in a driving apparatus according to this invention;

FIG. 7 is a circuit diagram showing an example of the construction of scanning potential setting means in FIG. 6;

FIG. 8 is a circuit diagram showing another example of the construction of scanning potential setting means; and

FIG. 9 is a circuit diagram showing still another example of the construction of scanning potential setting means in FIG. 6.

### DETAILED DESCRIPTION OF THE PREFERRED EMBODIMENTS

Hereinafter, a driving apparatus of a light emitting display panel according to this invention will be described based on embodiments shown in the drawings. As described above, the basic concept of the driving apparatus according to this invention is to variably control a scanning selecting potential according to the rate PN of light emitting devices to be scanned and lighted.

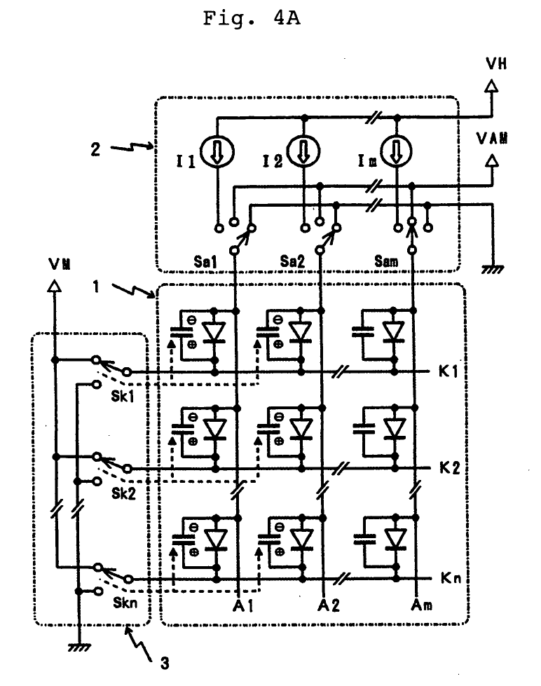

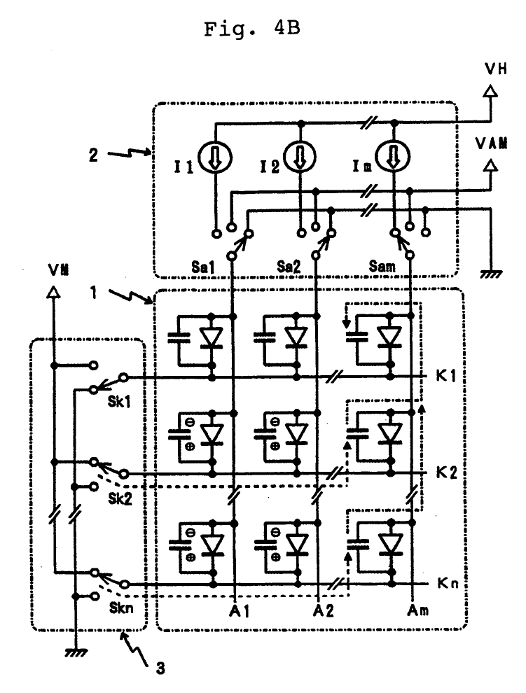

That is, as shown by broken lines in FIG. 4B, the amount of current (above-mentioned detouring current) flowing into the organic EL devices that correspond to the anode line Am and are not scanned from the reverse bias voltage power source VM is correctly controlled by variably controlling the above-mentioned scanning selecting potential. With this, it is possible to prevent the emission luminance of the organic EL devices to be scanned and lighted from rising up as described above and, as a result, to prevent the occurrence of the above-mentioned shadowing.

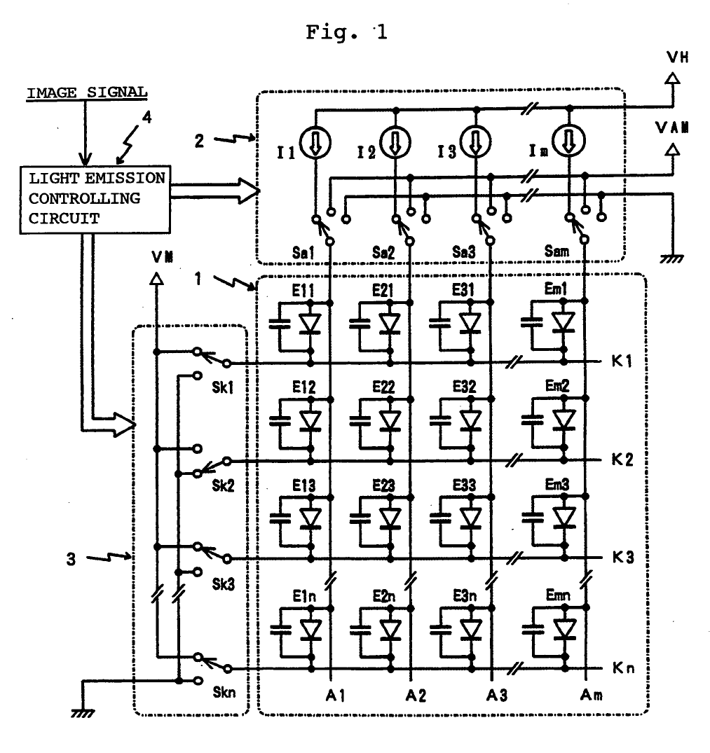

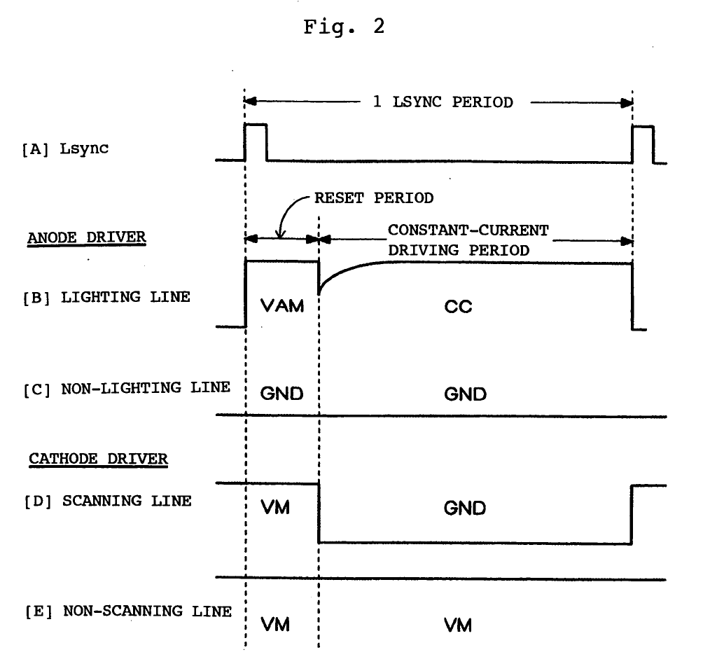

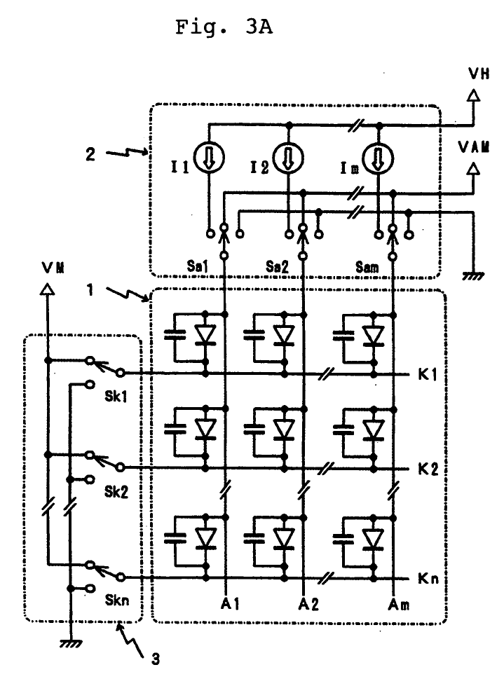

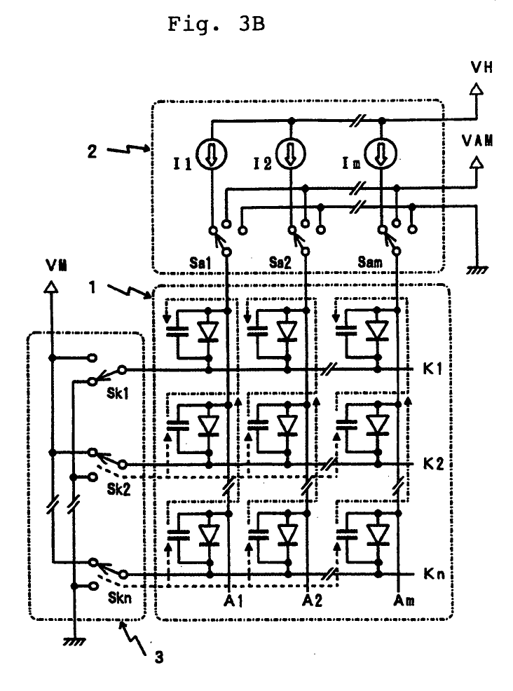

The driving apparatus according to this invention basically employs the same circuit construction as the construction described already and shown in FIG. 1 and has a reset period and a constant-current driving period (lighting period) set in synchronization with the scanning synchronous signal shown in FIG. 2. Here, in the embodiments to be described below, parts performing the same functions as the constituent parts shown in the respective drawings described already are denoted by the same reference characters.

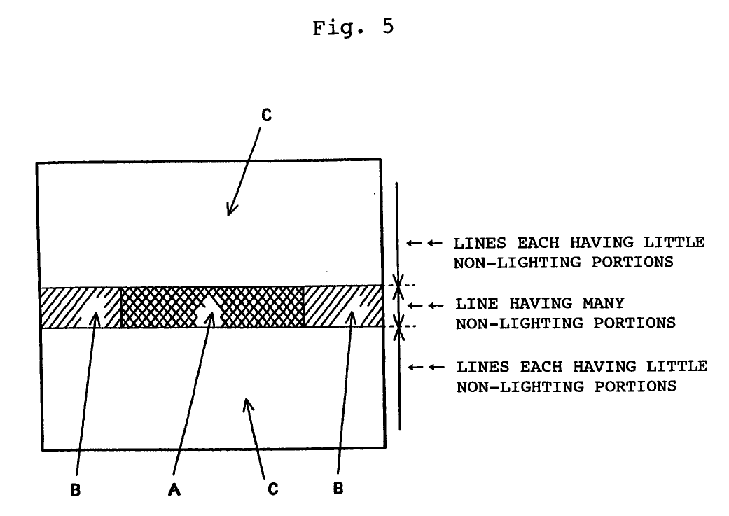

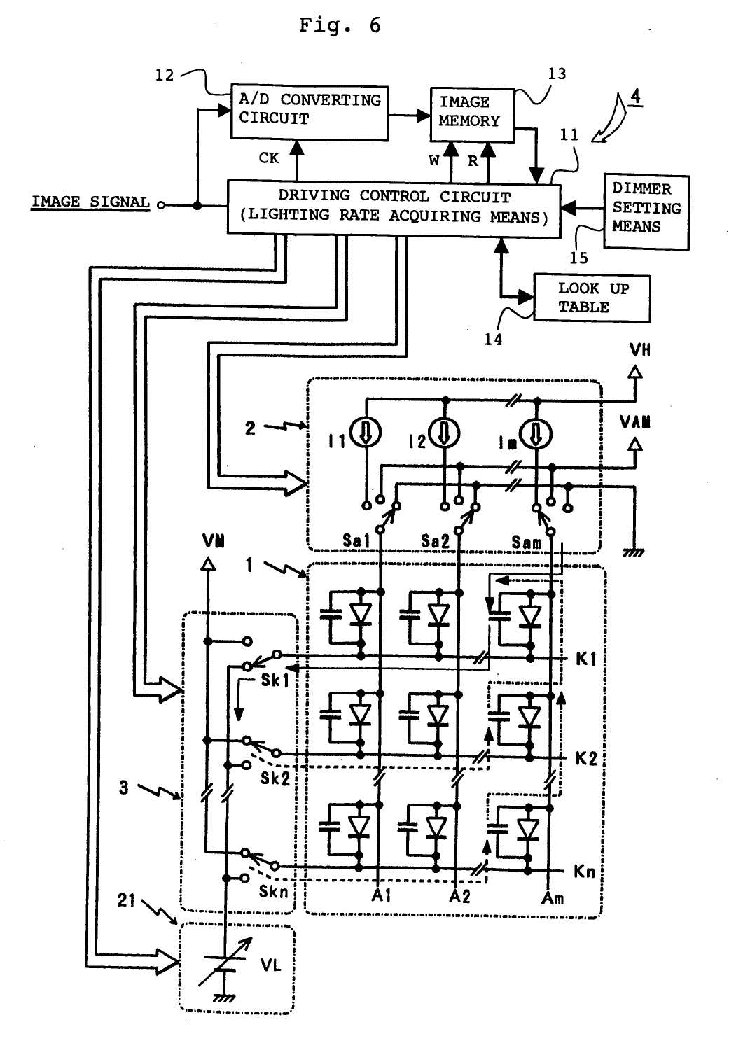

FIG. 6 shows an example in which a detailed construction corresponding to a light emission controlling circuit 4 and the construction of variably controlling a scanning selecting potential are added to the construction shown in FIG. 1. An analog image signal is supplied to the light emission controlling circuit 4 shown in this FIG. 6. That is, this analog image signal is supplied to a driving controlling circuit 11 and analog/digital (A/D) converting circuit 12 constructing the light emission controlling unit 4.

The above-mentioned driving controlling circuit 11 produces a clock signal CK to the A/D converting circuit 12 and a write signal W and a read signal R to an image memory 13 based on a horizontal synchronous signal and a vertical synchronous signal in the analog image signal. Then, the driving controlling circuit 11 outputs switching signals to the driving switches in the data driver 2 shown in FIG. 1 and scanning switching signals to the scanning driver 3 as scanning selecting means based on the horizontal synchronous signal and the vertical synchronous signal.

The above-mentioned A/D converting circuit 12 samples an inputted analog signal based on the clock signal supplied from the driving controlling circuit 11 and converts the sampled analog signal to corresponding image data for each one pixel and supplies the converted image data to the image memory 13. The above-mentioned memory 13 operates in such a way as to sequentially write the respective pixel data supplied from the A/D converting circuit 12 to the image memory 13 by a writing signal W from the driving controlling circuit 11.

When a frame memory is employed as the image memory 13, data of one screen (m columns, n rows) in the display panel 1 is written by the above-mentioned writing operation. Then, when the writing of the data of one screen is finished, image data is read for each one row (one scanning) from the 1st row to the n-th row of the scanning lines by the reading signal supplied from the driving controlling circuit 11. Then, the driving controlling circuit 11 operates in such a way as to acquire the rate PN of the organic EL devices to be lighted and controlled (lighting rate of the organic EL devices for each one scanning) from the image data of each one row. In other words, the driving controlling circuit 11 functions as means for acquiring the lighting rate of the organic EL devices.

Then, the driving controlling circuit 11 is constructed in such a way as to be supplied with the data of dimmer control from dimmer setting means 15 and is constructed in such a way as to dimmer display the display panel 1 in D (D=1 to d) steps by the data of dimmer control. This dimmer setting means 15 has a dimmer value set manually in some cases, and in the case of a mobile device or the like, the dimmer setting means 15 receives outside light to have automatically a dimmer value set.

The driving controlling circuit 11 is constructed as one mode in such a way that the data of a scanning selecting potential corresponding to the above-mentioned lighting rate PN for each scanning is found from a look-up table 14 and that the data of a scanning selecting potential found from this look-up table 14 is supplied to scanning potential setting means shown by a reference character 21 in FIG. 6. According to this construction, the scanning potential setting means 21 operates in such a way as to change a scanning selecting potential according to the lighting rate of the organic EL devices for each one scanning. Then, the above-mentioned operation is performed in sequence from the 1st scanning line to the n-th scanning line (N=1 to n) in synchronization with the scanning of the scanning driver 3.

The scanning potential setting means 21 is shown as a variable voltage power source in FIG. 6 and operates in such a way as to have its one terminal (negative terminal) connected to the grounding potential GND and to have its other terminal (positive terminal) connected to a scanning line scanned and selected by the scanning driver 3. With this construction, a scanning selecting voltage VL controlled according to the above-mentioned lighting rate PN can be applied to a scanning line scanned and selected.

The driving controlling circuit 11 is constructed as another mode in such a way that the data a scanning selecting potential is found from the look-up table 14 from the above-mentioned lighting rate PN for each scanning and the data of the above-mentioned dimmer control and that the scanning selecting potential found from this look-up table 14 is supplied to scanning potential setting means shown by the reference character 21 in FIG. 6.

According to this construction, the data of a scanning selecting potential read from the look-up table 14 according to the lighting rate of the organic EL devices for each one scanning and the data of the dimmer control set at this time is supplied to the scanning potential setting means 21. In this case, the look-up table 14 is constructed in the shape of a map (two dimension) from which the data of a scanning selecting potential can be found from the lighting rate of the organic EL devices and the data of the dimmer control.

The lighting controlling state of the organic EL devices in the display panel 1 shown in FIG. 6 shows a state in a lighting period when the lighting rate of the organic EL devices is low just as with the case in FIG. 4B described already. According to this example, as already described, current transiently flowing into the anode side of the organic EL devices to be scanned and lighted from the reverse bias voltage power source VM via the respective cathode lines K2 to Kn in the non-scanning state and the anode line Am to be lighted increases as compared with the case when the lighting rate PN is high and hence the degree of rise in the luminance at the beginning of light emission of the organic EL devices to be scanned and lighted becomes remarkable.

Then, the potential of the scanning lines to be scanned and selected can be increased by increasing the value (level) of the scanning selecting potential VL in the scanning potential setting means 21 to prevent current transiently flowing into the anode side of the organic EL devices to be scanned and lighted from the reverse bias voltage power source VM. With this, the degree of occurrence of the above-mentioned shadowing can be reduced.

In this regard, the operation of preventing the above-mentioned shadowing is for the above-mentioned “bright transverse cross talk” and in the case of preventing the “dark transverse cross talk”, it is also effective to change circuit design in such a way as to replace the positive terminal with the negative terminal of a variable voltage power source in the scanning potential setting means 21 shown in FIG. 6. Then, even a construction in which in the state shown in FIG. 6, the negative terminal in the variable voltage power source is connected to a negative voltage power source (not shown) can also prevent the “dark transverse cross talk”.

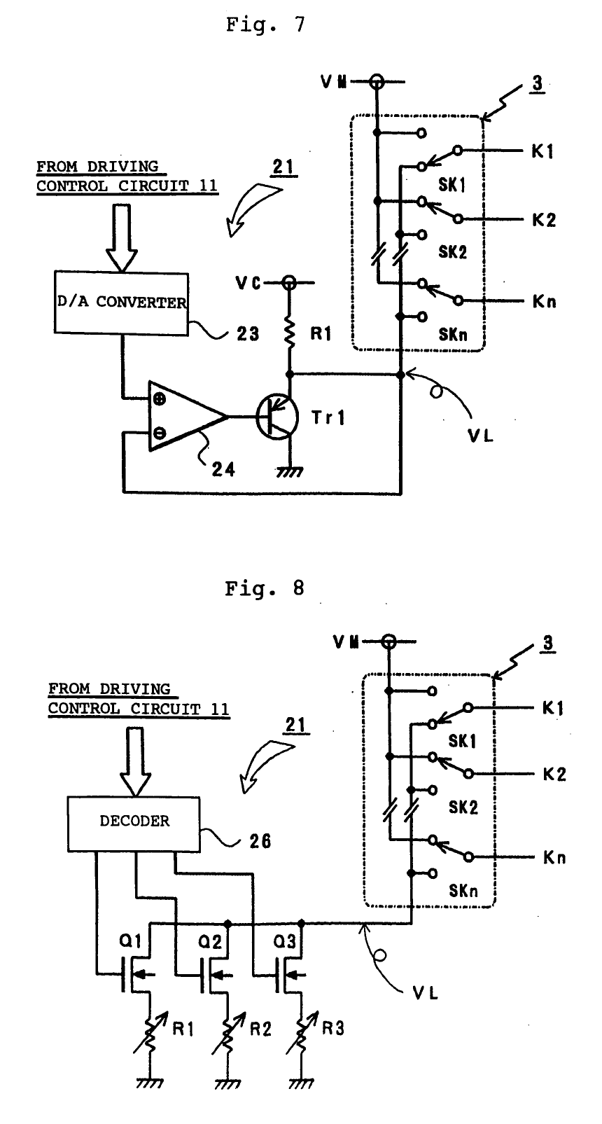

FIG. 7 shows one example of the specific construction of the scanning potential setting means 21 and shows a portion of the scanning potential setting means 21 and the scanning driver 3. The scanning potential setting means 21 shown in this FIG. 7 is provided with a D/A converter 23 and the D/A converter 23 is constructed in such a way as to have the data of a scanning selecting potential corresponding to the lighting rate of the organic EL devices supplied thereto as digital data. Then, an analog voltage converted by the D/A converter 23 is supplied to the non-inverted input terminal of an operational amplifier 24.

The output terminal of the operational amplifier 24 is connected to the base electrode of a pnp type transistor Tr1 having its collector electrode grounded and the emitter electrode of the transistor Tr1 is connected to an operating power source Vc via a resistor R1. Then, the emitter electrode of the transistor Tr1 is constructed in such a way as to be connected to the scanning selecting line via the scanning switches Sk1 to Skn in the scanning driver 3 and the emitter electrode of the transistor Tr1 is connected to the inverted input terminal of the operational amplifier 24.

According to the above-mentioned construction of the scanning potential setting means 21, the operational amplifier 24 adjusts the amount of current flowing from the emitter electrode of the transistor Tr1 to a collector electrode according to an analog voltage converted by the D/A converter 23. That is, a divided voltage into which the operating power source Vc is divided by the transistor Tr1 and the resistor R1 is produced at the emitter electrode and this emitter potential becomes the above-mentioned scanning selecting potential VL. Then, the emitter potential is supplied as a feedback signal to the inverted input terminal of the operational amplifier 24 to improve the linearity of the scanning selecting potential VL produced at the emitter electrode of the transistor Tr1 corresponding to the analog voltage from the D/A converter 23.

According to the construction shown in FIG. 7, the level of the scanning selecting potential VL is changed up and down according to a change in the analog voltage converted by the D/A converter 23, whereby the potential of the scanning line scanned and selected can be controlled according to the change. Therefore, as described based on FIG. 6, current transiently flowing into the anode side of the organic EL devices to be scanned and lighted from the reverse bias voltage power source VM can be controlled as appropriate. With this, the degree of occurrence the above-mentioned shadowing can be effectively reduced.

Moreover, when the digital data (data of scanning selecting potential) supplied to the D/A converter 23 is based on the lighting rate of the organic EL devices for each one scanning and the data of the dimmer control set at this time, not only the shadowing can be corrected by the lighting rate of the organic EL devices but also the occurrence of the shadowing can be effectively controlled particularly at the time of low dimmer.

FIG. 8 shows another example of the specific construction of the scanning potential setting means 21. In FIG. 8 is similarly showed a portion of the scanning potential setting means 21 and the scanning driver 3. The scanning potential setting means 21 shown in this FIG. 8 is provided with a decoder 26 and the decoder 26 is so constructed as to have the data of a scanning selecting potential corresponding to the lighting rate of the organic EL devices supplied thereto as binary data. Then, the decoder 26 is so constructed as to be able to turn on any one of FETS Q1 to Q3 functioning as analog switches based on the binary data.

The source electrodes of the FETs Q1 to Q3 have the other ends of resistor devices R1 to R3, whose one ends are connected to a common potential (grounding potential GND in the example shown in FIG. 8) and whose resistances are different from each other, connected thereto, respectively. Then, the drain electrodes of the FETs Q1 to Q3 are connected in common to each other and are connected to the scanning selecting lines via the scanning switches Sk1 to Skn in the scanning driver 3, respectively.

According to the above-mentioned construction of the scanning potential setting means 21, the decoder 26 turns on any one of the FETs Q1 to Q3 functioning as connecting means based on the data of the scanning selecting potential supplied from the driving controlling circuit 11 based on the lighting rate of the organic EL devices. With this, the scanning selecting lines are connected to the grounding potential GND via any one of the resistor devices R1 to R3, respectively. In other words, the scanning selecting voltage VL is changed by the selection of the resistor devices R1 to R3.

Therefore, according to the construction shown in FIG. 8, by selecting the resistor devices R1 to R3 by the decoder 26, the level of the scanning selecting potential VL can be substantially changed up and down. Therefore, as described based on FIG. 6, current transiently flowing into the anode side of the organic EL devices to be scanned and lighted from the reverse bias voltage power source VM can be controlled by the correct selection of the resistor devices R1 to R3, whereby the degree of occurrence of the above-mentioned shadowing can be effectively reduced.

Then, when the data of the scanning selecting potential supplied to the decoder 26 is based on the lighting rate of the organic EL devices for each one scanning and the data of the dimmer control set at this time, not only the shadowing can be corrected by the lighting rate of the organic EL devices but also the occurrence of the shadowing can be effectively controlled particularly at the time of low dimmer.

In this regard, in the embodiment shown in FIG. 8, the respective FETs Q1 to Q3 function as analog switches. However, the respective FETs Q1 to Q3 can be also constructed in such a way that on-resistances (electric resistance between the drain and the source) when they have the gate potential applied thereto to be turned on are different from each other. For example, by adjusting the gate lengths of the respective FETs, different on-resistances can be realized. Therefore, when the FETs having different on-resistances are employed, the resistor devices R1 to R3 can be omitted.

Moreover, in the construction shown in FIG. 8, one of three resistor devices R1 to R3 is selected. However, needless to say, more resistor devices can be provided. Furthermore, by using three resistor devices R1 to R3 and controlling two or more resistor devices in parallel as appropriate, resistance can be changed at more steps.

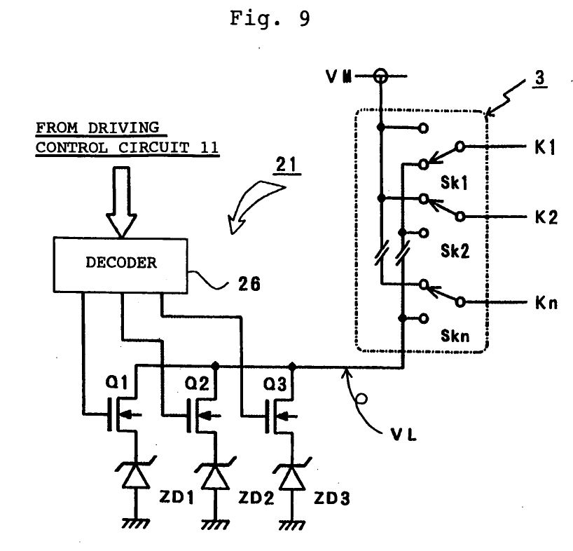

FIG. 9 shows still another example of the specific construction of the scanning potential setting means 21. In the example shown in this FIG. 9, in place of the resistor devices R1 to R3 shown in FIG. 8, Zener diodes ZD1 to ZD3 having different Zener voltages are used. That is, the scanning potential setting means 21 is constructed such that the anode terminals of the respective Zener diodes ZD1 to ZD3 are connected to a common potential (grounding potential GND) and that a cathode terminal of any one of them is connected to the scanning line to be scanned and selected via the FETs Q1 to Q3 functioning as connecting means.

According to the construction using the Zener diodes ZD1 to ZD3, the scanning selecting potential VL can be set by Zener voltages specific to the respective Zener diodes ZD1 to ZD3. That is, like the case of using the resistor devices R1 to R3 shown in FIG. 8, it is possible to prevent the scanning selecting potential VL from being varied by current flowing through the scanning line.

Also in the construction shown in FIG. 9, the shadowing caused by a decrease in the lighting rate of the organic EL devices can be corrected. In addition to this, the occurrence of shadowing particularly at the time of low dimmer can be effectively controlled.

In the embodiments described above, the examples using the organic EL devices as light emitting devices arranged in the display panel have been shown. However, the same operation and effect can be acquired even in the case of using other capacitive devices as the light emitting devices. Moreover, the above-mentioned embodiments are constructed such that the data of the scanning selecting potential is read from the look-up table based on the lighting rate of the organic EL devices and the data of the dimmer control. However, this data of the scanning selecting potential may be found by logic operation.

What is claimed is:

1. A driving apparatus of a light emitting display panel of a passive matrix type including a plurality of scanning lines, a plurality of data lines that intersect each other, and light emitting devices each of which is connected between each of the scanning lines and each of the data lines at an intersection of each of the scanning lines and each of the data lines, wherein the driving apparatus comprising:
scanning selecting means for applying a scanning selecting potential or a non-scanning selecting potential to each of the scanning lines;
lighting rate acquiring means for acquiring a rate PN of the light emitting devices to be lighted and controlled of the light emitting devices connected to the respective scanning lines; and
scanning potential setting means capable of controlling the scanning selecting potential based on the rate PN acquired by the lighting rate acquiring means.

2. A driving apparatus of a light emitting display panel of a passive matrix type including a plurality of scanning lines, a plurality of data lines that intersect each other, and light emitting devices each of which is connected between each of the scanning lines and each of the data lines at an intersection of each of the scanning lines and each of the data lines, wherein the driving apparatus comprising:
scanning selecting means for applying a scanning selecting potential or a non-scanning selecting potential to each of the scanning lines;
lighting rate acquiring means for acquiring a rate PN of the light emitting devices to be lighted and controlled of the light emitting devices connected to the respective scanning lines;
dimmer controlling means for dimmer displaying the display panel at D (D=1 to d) steps; and
scanning potential setting means capable of controlling the scanning selecting potential based on the rate PN acquired by the lighting rate acquiring means and a step D of dimmer control by the dimmer controlling means.

3. The driving apparatus of a light emitting display panel according to claim 1, wherein the scanning potential setting means is provided with a D/A converter for converting data of a scanning selecting potential, which is acquired based on a rate PN of the light emitting devices to be lighted and controlled, to an analog potential.

4. The driving apparatus of a light emitting display panel according to claim 2, wherein the scanning potential setting means is provided with a D/A converter for converting data of a scanning selecting potential, which is acquired based on a rate PN of the light emitting devices to be lighted and controlled and a step D of dimmer control, to an analog potential.

5. The driving apparatus of a light emitting display panel according to claim 1, wherein the scanning potential setting means is provided with connecting means for connecting scanning lines to be scanned and selected to other end of one of resistor devices, each of which has its one end connected to a common potential and has different resistance, by data of a scanning selecting potential acquired based on a rate PN of the light emitting devices to be lighted and controlled.

6. The driving apparatus of a light emitting display panel according to claim 2, wherein the scanning potential setting means is provided with connecting means for connecting scanning lines to be scanned and selected to other end of one of resistor devices, each of which has its one end connected to a common potential and has different resistance, by data of a scanning selecting potential acquired based on a rate PN of the light emitting devices to be lighted and controlled and a step D of dimmer control.

7. The driving apparatus of a light emitting display panel according to claim 1, wherein the scanning potential setting means is provided with connecting means for connecting scanning lines to be scanned and selected to a cathode terminal of one of Zener diodes, each of which has its anode terminal connected to a common potential and has a different Zener voltage, by data of a scanning selecting potential acquired based on a rate PN of the light emitting devices to be lighted and controlled.

8. The driving apparatus of a light emitting display panel according to claim 2, wherein the scanning potential setting means is provided with connecting means for connecting scanning lines to be scanned and selected to a cathode terminal of one of Zener diodes, each of which has its anode terminal connected to a common potential and has a different Zener voltage, by data of a scanning selecting potential acquired based on a rate PN of the light emitting devices to be lighted and controlled and a step D of dimmer control.

9. The driving apparatus of a light emitting display panel according to any one of claims 5 to 8, wherein the common potential is a grounding potential.

10. The driving apparatus of a light emitting display panel according to claim 1 or claim 2, wherein the respective data lines have constant-current power sources selectively connected thereto and supply the light emitting devices to be lighted and controlled with lighting driving currents from the constant-current power sources.

11. The driving apparatus of a light emitting display panel according to claim 1 or claim 2, wherein the light emitting devices are organic EL light emitting devices each having one or more organic light emitting function layer between electrodes opposed to each other.

12. A driving method of a light emitting display panel of a passive matrix type including a plurality of scanning lines, a plurality of data lines that intersect each other, and light emitting devices each of which is connected between each of the scanning lines and each of the data lines at an intersection of each of the scanning lines and each of the data lines, wherein the driving method comprising:
a step of acquiring a rate PN of the light emitting devices to be lighted and controlled of the light emitting devices connected to the respective scanning lines; and
a step of controlling a scanning selecting potential to be applied to scanning lines to be scanned based on the rate PN acquired by the step and supplying light emitting devices, which are connected to the scanning lines and are to be lighted, with lighting driving currents.

13. A driving method of a light emitting display panel of a passive matrix type including a plurality of scanning lines, a plurality of data lines that intersect each other, and light emitting devices each of which is connected between each of the scanning lines and each of the data lines at an intersection of each of the scanning lines and each of the data lines, wherein the driving method comprising:
a step of acquiring a rate PN of the light emitting devices to be lighted and controlled of the light emitting devices connected to the respective scanning lines and a data of dimmer control for dimmer displaying the display panel at D (D=1 to d) steps; and
a step of controlling a scanning selecting potential to be applied to scanning lines to be scanned based on the rate PN and data of dimmer control, which are acquired by the step, and supplying light emitting devices, which are connected to the scanning lines and are to be lighted, with lighting driving currents.
